(19) United States
(12) Patent Application Publication
(10) Pub. No.: US 2007/0271338 A1
(43) Pub. Date: Nov. 22, 2007

(54) Methods, systems, and products for synchronizing media experiences

(76) Inventor: Thomas Anschutz, Conyers, GA (US)

Correspondence Address: SCOTT P. ZIMMERMAN, PLLC, PO BOX 3822, CARY, NC, 27519, US

(21) Appl. No.: 11/437,016

(22) Filed: May 18, 2006

(51) Int. Cl. G06F 15/16

(52) U.S. Cl. 709/204

(57) ABSTRACT

Methods, systems, and products are disclosed for synchronizing a media experience. A request is received from a host device for a shared collaborative session between the host device and an invitee device. An invitation is sent to the invitee device to join the shared collaborative session. A common control is established between the host device and the invitee device such that a shared content stream is synchronously controlled by inputs from both the host device and from the invitee device.

### NOTICE OF COPYRIGHT PROTECTION

A portion of this disclosure and its figures contain material subject to copyright protection. The copyright owner has no objection to the facsimile reproduction by anyone of the patent document or the patent disclosure, but otherwise reserves all copyrights whatsoever.

### BACKGROUND

This application generally relates to interactive video distribution systems and to computers and, more particularly, to synchronized media experiences.

Personal, online interactions are growing in popularity. Many people are very comfortable using electronic communications to conduct conversations. Instant messaging, text messaging, and email, for example, are examples of today's communications environment. Previous generations favored face-to-face conversations, but today's generations are more comfortable with online, real-time electronic messaging and communications.

Because today's interactions are conducted online, users still want to share communicative experiences. Even though people may be remotely located from one another, people still want cultural bonding. Online users want to share their life experiences, despite the distances that often separate users. For example, online users may want to share the experience of watching a movie with a remote friend in another house or another city. As an online user watches a movie, for example, that online user may naturally want to share that movie-viewing experience with remote friends and/or family. What is needed, then, are methods, systems, and products that allow multiple users to synchronize their media experiences.

### SUMMARY

The aforementioned problems, and other problems, are reduced, according to exemplary embodiments, using methods, systems, and products that synchronize media experiences. Exemplary embodiments allow multiple users to collaboratively control shared media content. As multiple users watch, listen to, or otherwise experience shared content, exemplary embodiments permit all the users to synchronously experience the shared content. If one user enters a “pause” command to pause the shared content, then the other users also experience a pause. If another user enters a “rewind” command to again experience a scene, then the other users also again experience that same scene. Exemplary embodiments even allow remote users to share text messages and/or audio commentary, such as “Wow, great shot!” or “I need something to drink.” Exemplary embodiments even share graphical commentary, such as circles drawn on the display screen to highlight a key play. So, whether the users share a video-on-demand, listen to music, or play a game, exemplary embodiments allow users in different homes, towns, or states to share the same media experience, thus creating the illusion of a “virtual” presence of each user.

The exemplary embodiments describe a method for synchronizing a media experience. A request is received from a host device for a shared collaborative session between the host device and an invitee device. An invitation is sent to the invitee device to join the shared collaborative session. A common control is established between the host device and the invitee device such that a shared content stream is synchronously controlled by inputs from both the host device and from the invitee device.

In another of the embodiments, a system is disclosed for synchronizing a media experience between multiple devices at remote or diverse locations. The system comprises a collaborative control application stored in memory, and a processor communicates with the memory. The processor receives a request from a host device for a shared collaborative session between the host device and an invitee device. The processor sends an invitation to the invitee device to join the shared collaborative session. The processor establishes a common control between the host device and the invitee device such that a shared content stream is synchronously controlled by inputs from both the host device and from the invitee device.

In yet another embodiment, a computer program product is also disclosed for synchronizing a media experience between multiple devices. The computer program product comprises a computer-readable medium storing computer code. This computer code causes receipt of a request from a host device for a shared collaborative session between the host device and an invitee device. An invitation is sent to the invitee device to join the shared collaborative session. A common control is established between the host device and the invitee device such that a shared content stream is synchronously controlled by inputs from both the host device and from the invitee device.

Other systems, methods, and/or computer program products according to the exemplary embodiments will be or become apparent to one with ordinary skill in the art upon review of the following drawings and detailed description. It is intended that all such additional systems, methods, and/or computer program products be included within this description, be within the scope of the claims, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a simplified schematic illustrating a network environment in which exemplary embodiments may be implemented;

FIG. 2 is a more detailed schematic illustrating the operating environment, according to exemplary embodiments;

FIG. 3 is a schematic illustrating a process of synchronizing media experiences between users, according to more exemplary embodiments;

FIGS. 4-6 are schematics illustrating another process of synchronizing media experiences between users, according to still more exemplary embodiments;

FIGS. 7-9 are schematics illustrating yet another process of synchronizing media experiences between users, according to more exemplary embodiments;

FIG. 10 is a schematic illustrating yet another process of synchronizing media experiences between users, according to still more exemplary embodiments;

FIG. 11 is a schematic illustrating yet another process of synchronizing media experiences between users, according to still more exemplary embodiments;

FIG. 12 is a schematic illustrating a process of synchronizing media experiences between users, according to exemplary embodiments; and

FIG. 13 depicts other possible operating environments, according to more exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

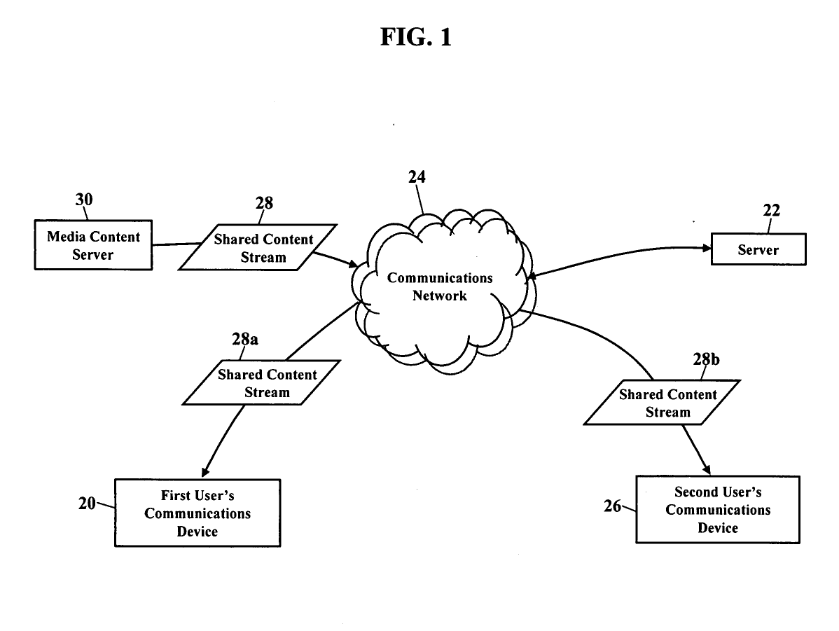

FIG. 1 is a simplified schematic illustrating a network environment in which exemplary embodiments may be implemented. A first user's communications device 20 communicates with a server 22 via a communications network 24. A second user's communications device 26 also communicates with the server 22 via the communications network 24. As later paragraphs will explain, the server 22 controls and/or manages collaboratively controlled content that is sent to the first user's communications device 20 and to the second user's communications device 26. Although each user's communications device 20 and 26 is generically shown, the communications devices 20 and 26, as will be later explained, may be any computer, analog/digital video recorder, set top box, personal digital assistant, cordless/cellular/IP phone, or any other processor-controlled device. Whatever the first 20 and the second 26 communications devices, each device receives a shared content stream 28. The shared content stream 28 includes any media, whether movies, pictures, images, music, text, links, programs, and data. The shared content stream 28 may be locally or remotely obtained. For simplicity, though, FIG. 1 illustrates the shared content stream 28 originating from a third party media content server 30 via the communications network 24. As the following paragraphs will explain in greater detail, exemplary embodiments permit both users to synchronously experience the shared content stream 28. Should the first user (at the first user's communications device 20) enter a “pause” command, for example, to pause the content stream 28, then the second user (at the second user's communications device 26) also experiences a pause. If the second user (at the second user's communications device 26) enters a “rewind” command to again experience a scene, then the first user (at the first user's communications device 20) also again experiences that same scene. Exemplary embodiments, then, synchronize each user's media experience. The first and second users may share the same experience, whether viewing a video-on-demand, listening to music; or playing a game. Exemplary embodiments, as later paragraphs will explain, include sharing text and/or audio commentary, such as “we've got to see that again” or “great shot!” So, even if the users are in different homes, towns, or states, exemplary embodiments permit those users to share the same media experience to create the illusion of a “virtual” presence of each other.

The shared content stream 28, however, need not be identical for each user. In perhaps a simplest embodiment the shared content stream 28 may be nearly identical for each user. The first user at the first user's communications device 20, for example, may receive a movie, while the second user at the second user's communications device 26 may receive the same movie with enhancements (e.g., extra scenes, languages, and/or subtitles). In other embodiments, when the first user pauses or rewinds, the second user continues watching the content at a normal bit rate. When the first user desires to rejoin the synchronous experience, the first user's communications device 20 advances, skips, or otherwise forwards to the scene being received by the second user's communications device 26. The second user, as another example, may request a movie without commercials, or with special scenes, and the first user may wish to only receive the movie (e.g., without frills). The server 22 may still synchronize the experiences for each device, despite differences in the content. The shared content streams 28, then, need not be identical and may only share a common timing reference or scene reference.

Exemplary embodiments are applicable to any number of users. FIG. 1, for simplicity, only illustrates two users (e.g., the first user at the first user's communications device 20 and the second user at the second user's communications device 26). Exemplary embodiments, however, may be used to establish a shared collaborative session between any number of users. Exemplary embodiments permit all the users, no matter how many, to synchronously experience the shared content stream 28. Exemplary embodiments allow all the users to share the same media experience, thus creating a virtual group experience.

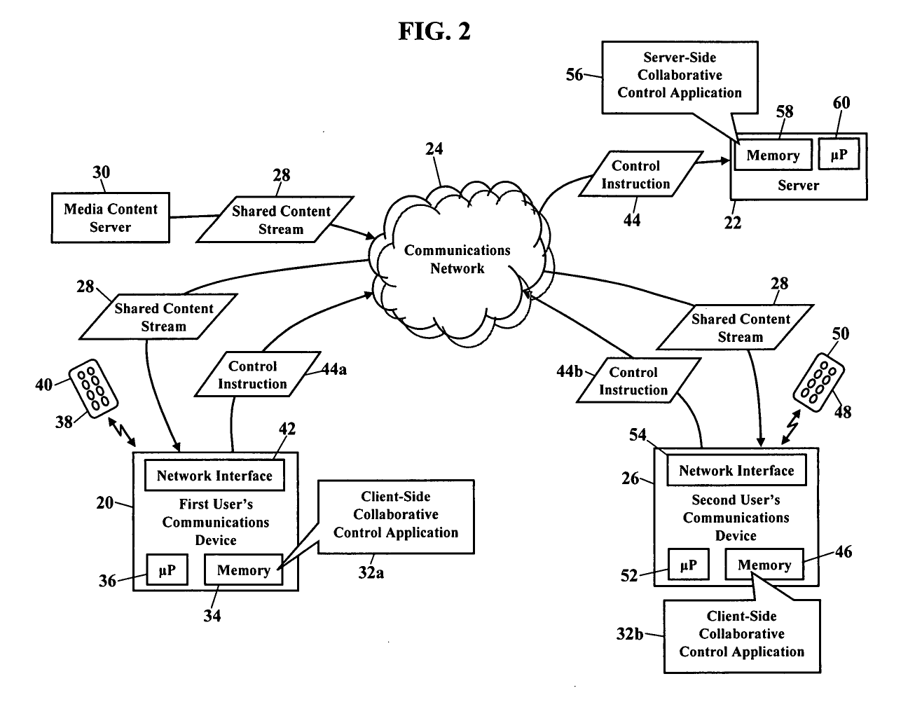

FIG. 2 is a more detailed schematic illustrating the operating environment, according to exemplary embodiments. The first user's communications device 20 stores a client-side collaborative control application 32a in memory 34. The client-side collaborative control application 32a is a software engine that collaboratively controls shared content. The client-side collaborative control application 32a includes processor-executable code or instructions that cause a processor (“μP”) 36 to process inputs received from a user interface 38. The user interface 38 is illustrated as a remote control 40, but the user interface 38 may be a control panel, keypad, keyboard, display, or any other means for receiving spoken, tactile, or any other type of inputs. The processor 36 receives an input via the user interface 38, and the input instructs the processor to implement or issue some instruction to control the shared content stream 28 received via the communications network 24. The client-side collaborative control application 32a instructs the processor 36 to invoke a network interface 42 to communicate a control instruction 44a to the server 22. The processor 30 thus sends the control instruction 44a via the communications network 24 to a communications or network address associated with the server 22.

FIG. 2 also illustrates the second user's communications device 26. The second user's communications device 26 also stores a client-side collaborative control application 32b in memory 46. (The client-side collaborative control application 32a operating in the first user's communications device 20 is compatible with, but perhaps slightly different from, the client-side collaborative control application 32b operating in the second user's communications device 26.) The second user's communications device 26 also receives inputs via a user interface 48 (again, for simplicity, illustrated as a remote control 50). The client-side collaborative control application 32b, operating in the second user's communications device 26, instructs a processor 52 to invoke a network interface 54 to communicate the one or more control instructions 44b received from the user interface 48. (The control instructions 44b from the second user's communications device 26 may, yet need not, be identical to the control instructions 44a sent from the first user's communications device 20.) The processor 30 may send the control instruction(s) 44b via the communications network 24 to the communications or network address associated with the server 22. The processor 30 may additionally or alternatively send the control instruction(s) 44b via the communications network 24 to the first user's communications device 20, as later paragraphs will explain.

FIG. 2 also illustrates the server 22. The server 22 stores a server-side collaborative control application 56 in memory 58. The server-side collaborative control application 56 is a software engine that establishes, controls, and/or manages collaboratively controlled content. The server-side collaborative control application 56 includes processor-executable code or instructions that cause a processor (“μP”) 60 to receive and to process the control instruction(s) 44, as the following paragraphs further explain.

The users' communications devices 20 and 26, and the server 22, are only simply illustrated. Because the architecture and operating principles of computers, communications devices, and other processor-controlled devices are well known, details of the hardware and software components of the users' communications devices 20 and 26, and the server 22, are not further shown and described. If, however, the reader desires more details, the reader is invited to consult the following sources, all incorporated herein by reference in their entirety: ANDREW TANENBAUM, COMPUTER NETWORKS (4^{th} edition 2003); WILLIAM STALLINGS, COMPUTER ORGANIZATION AND ARCHITECTURE: DESIGNING FOR PERFORMANCE (7^{th} edition 2005); and DAVID A. PATTERSON & JOHN L. HENNESSY, COMPUTER ORGANIZATION AND DESIGN: THE HARDWARE/SOFTWARE INTERFACE (3^{th} Edition 2004).

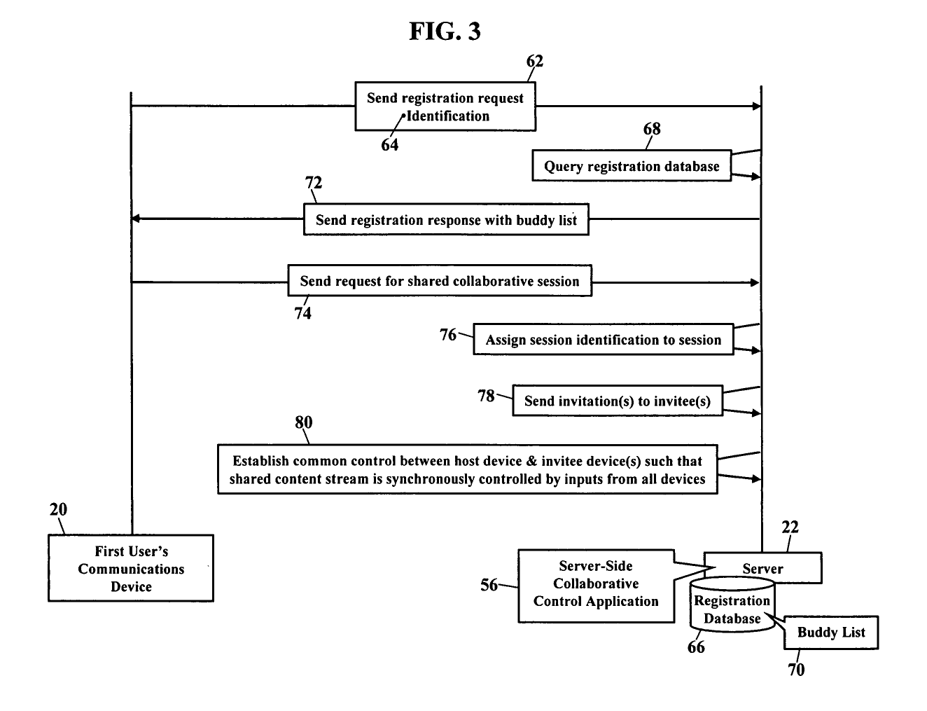

FIG. 3 is a schematic illustrating a process of synchronizing media experiences between users, according to more exemplary embodiments. FIG. 3 illustrates data, inputs, messages, instructions, and/or other communications that are communicated between the first user's communications device 20 and the server 22 to establish a shared, collaborative session. Here the first user's communications device 20 sends a registration request to the server 22 (Step 62). The registration request seeks to register for shared, collaborative session experiences with other users (such as the second user). The registration request may include any identification 64 that uniquely identifies the first user's communications device 20. The identification 64 may be any name or number, such as a static or dynamic I.P. address, other communications address, processor identification number, or user name.

The server 22 accesses a registration database 66. When the server 22 receives the registration request, the server-side collaborative control application 56 queries the registration database 66 (illustrated as Step 68), which may be included as part of the server 22 or may be a separate device. The registration database 66 stores, maps or otherwise associates the identification 64 to members in a buddy list 70. The registration database 66 may also store the content currently being received by each member in the buddy list 70. That is, registration database 66 tracks what content is currently being received by each member's device in the buddy list 70. If a member in the buddy list 70 is receiving a video-on-demand, the title (or other identifier) of that video is stored in the registration database 66. If a member is receiving a game feed or stream, the title of that game is stored in the registration database 66. Whatever content each buddy is receiving, the buddy list 70 is updated with each member's current content. The buddy list 70 may even receive updates describing presence information and/or capabilities of each member's device(s). After the server 22 queries the registration database 66, the server 22 sends a registration response (Step 72). The registration response includes information that identifies the content being received by each member's device in the buddy list 70.

The first user may invite one or more others to share a media experience. When the first user's communications device 20 receives the registration response, the first user knows the online status of each member of the buddy list 70. If a buddy has an online presence, the first user may also know what content that buddy is currently receiving. Suppose the first user wants more than a solo experience. The first user, instead, selects one or more members from the buddy list 70 for a shared collaborative session. The buddy list 70 may be presented as a list, window, pop-up, or other graphical interface that lists each member of the buddy list 70. The first user selects one or more members from the buddy list 70. The user may even depress, select, or otherwise activate a collaboration button (e.g., on the remote control 40 shown in FIG. 2). However the buddies are chosen, the first user's communications device 20 sends a request for a shared collaborative session (Step 74). The request includes information that identifies each buddy and/or each buddy's device selected for the shared collaborative session. Because the first user has requested the shared collaborative session, the first user may be considered the “host” of the session. The first user's communications device 20 may, likewise, be termed the “host” device.

Session invitations are sent. When the server 22 receives the request for the shared collaborative session, the server-side collaborative control application 56 assigns a session identification to the session (Step 76). The server-side collaborative control application 56 causes the server 22 to send invitations to each invitee (Step 78). The server 22, for example, may send an invitation to the second user at the second user's communications device (shown as reference numeral 26 in FIGS. 1 and 2). Each invitation invites the addressee to join the shared collaborative session. Each invitation may include the session identification. Each invitation may identify the host and/or the host device and the content that will be shared. Each invitation may also include information that describes the start and stop times of the shared experience and the names of one or more of the other invitees. The server-side collaborative control application 56 establishes a common control between the host device and the invitee device(s) such that a shared content stream is synchronously controlled by inputs from both the host device and from the invitee device(s) (Step 80). The session, however, may be pre-arranged a priori from some other device (that is, some device other than the first user's or the second user's). Any synchronous session participants join the session (similar to a pre-arranged conference bridge).

The collaborative session need not be by invitation. FIG. 3 illustrates the first user sending invitations to others to share a media experience. Other exemplary embodiments, however, do not require invitations. Multiple users may synchronously share media content, even if one or more users are not in the buddy list 70. Anytime a user registers, the user may be informed of opportunities for shared experiences. The server-side collaborative control application 56 may inform the registering user of any opportunities for shared experiences. The server-side collaborative control application 56, for example, may link anonymous and/or virtual buddies. The server-side collaborative control application 56 may also link a user to a computer avatar that mimics the situation one might encounter by watching a football game in a room of strangers. Suppose, also, that multiple users simultaneously request a football game or other sporting event and, thus, wish to synchronize their viewing experience.

Peer selections may be important. Sometimes members buddy list 70 may be registered but not receiving a stream of content. Perhaps these buddies are online but not receiving content. When a friend requests a movie, though, the friend's buddies may wish to “jump[ in” and synchronously receive the same movie. In this case, then, peer selections may influence the amount of synchronous activity.

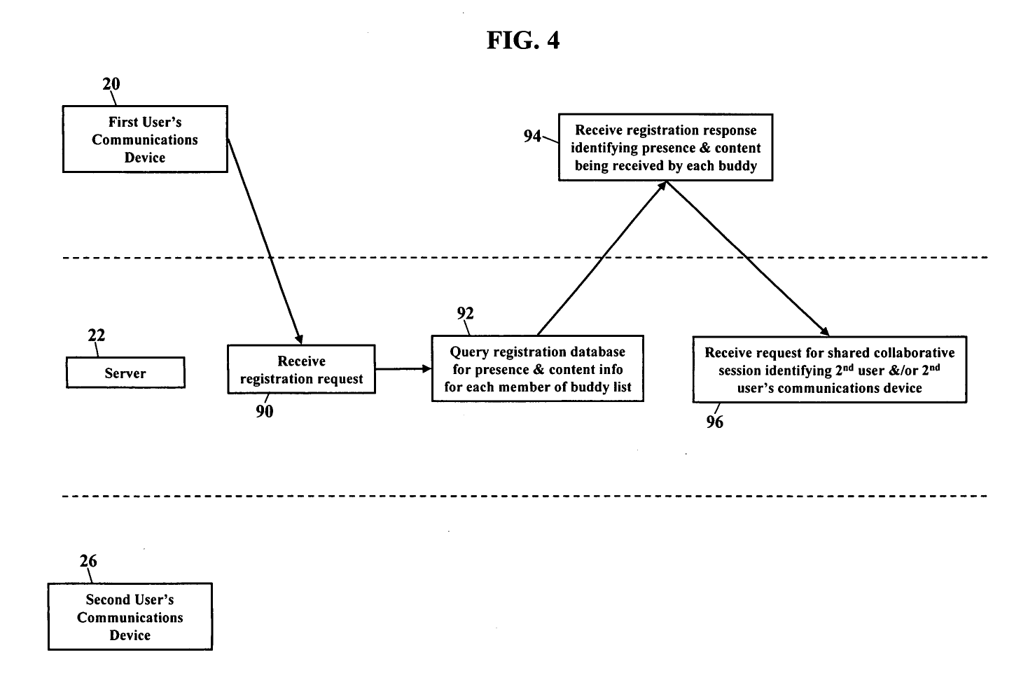

FIGS. 4-6 are schematics illustrating another process of synchronizing media experiences between users, according to still more exemplary embodiments. FIGS. 4-6 illustrate data, inputs, messages, instructions, and/or other communications that are communicated between the first user's communications device 20, the second user's communications device 26, and the server 22 to establish a shared, collaborative session. The first user's communications device 20 sends the registration request to the server 22 (Step 90). The server 22 queries the registration database for the presence information and content information for each member of the first user's buddy list (Step 92). The server 22 sends the registration response that identifies the presence of each buddy and the content being received by each buddy (Step 94). In this example the first user desires to establish a shared collaborative session with the second user (at the second user's communications device 26). The first user's communications device 20 thus sends the request for a shared collaborative session, and the request identifies the second user and/or the second user's communications device 26 (Step 96).

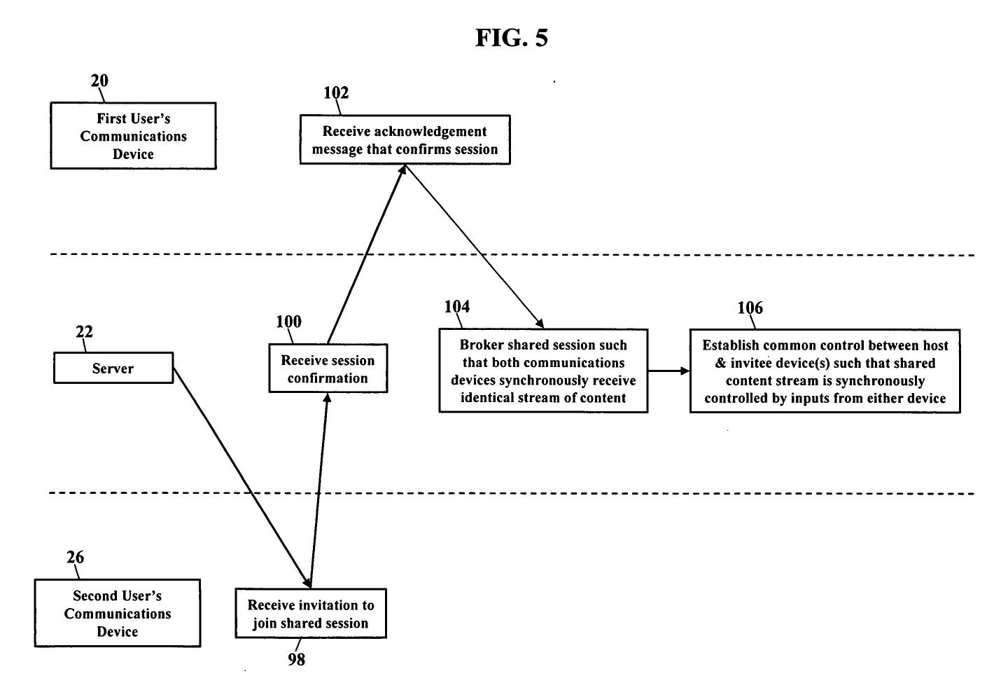

The process continues with FIG. 5. The server 22 sends an invitation to the second user's communications device 26 to join the shared session (Step 98). If the second user wishes to join the session, the second user's communications device 26 sends a session confirmation to the server 22 (Step 100). The server 22 sends an acknowledgement message to the first user's communications device 20 to confirm the session (Step 102). The server-side collaborative control application (shown as reference numeral 56 in FIGS. 2 and 3) then brokers a shared session, such that both the first user's communications device 20 and the second user's communications device 26 synchronously receive an identical stream of content (Step 104). The server-side collaborative control application establishes a common control between the host device (e.g., the first user's communications device 20) and the invitee device (e.g., the second user's communications device 26) such that the shared content stream is synchronously controlled by inputs from either the host device or from the invitee device (Step 106).

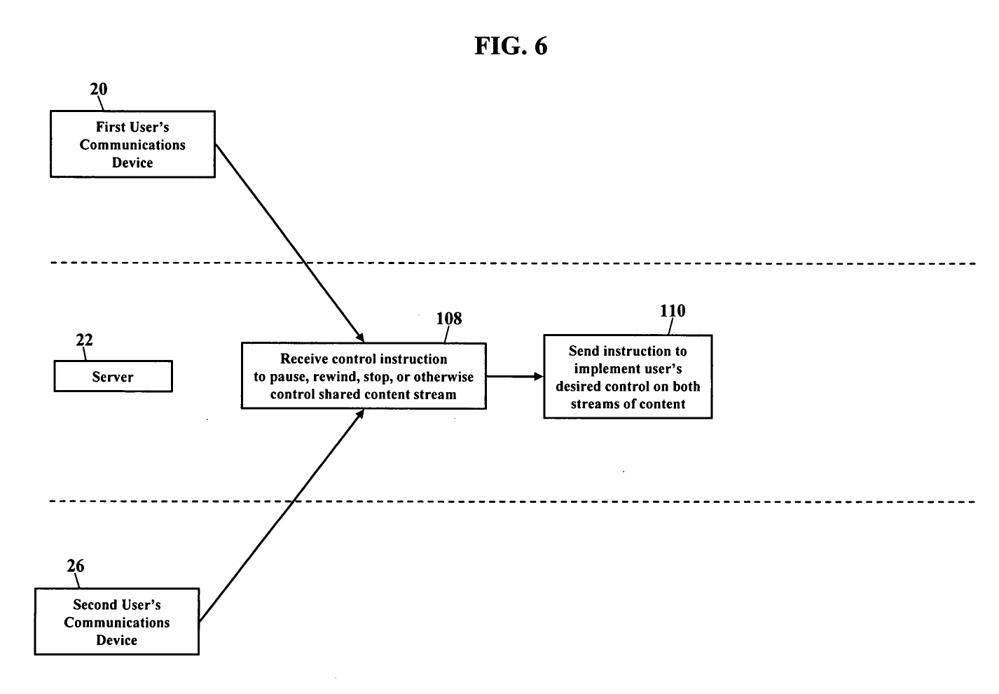

The process continues with FIG. 6. When the server 22 receives a control instruction or other input from either the first user's communications device 20 or the second user's communications device 20 to pause, rewind, stop, or otherwise control the shared content stream (Step 108), the server may send an instruction to the media content server (shown as reference numeral 30 in FIG. 1) to implement the user's desired control on both streams of content (Step 110). The control instruction or other input may request a pause, rewind, stop, or other control of the shared content stream.

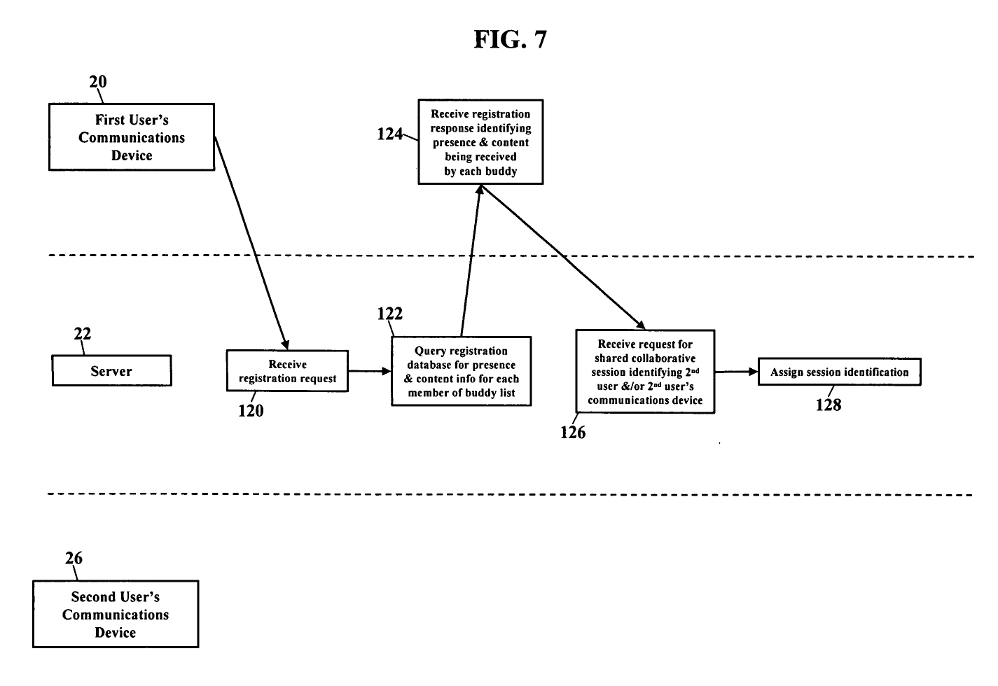

FIGS. 7-9 are schematics illustrating yet another process of synchronizing media experiences between users, according to more exemplary embodiments. Here all invitee inputs are routed through the designated “host” device. Because FIGS. 7-9 are similar to FIGS. 4-6, some features are cursorily explained. The first user's communications device 20 sends the registration request (Step 120). The server 22 queries the registration database buddy presence and content information (Step 122). The server 22 sends the registration response (Step 124). Because the first user desires to establish a shared collaborative session with the second user, the first user's communications device 20 sends the request for a shared collaborative session (Step 126). The server 22 assigns a session identification to the session (Step 128).

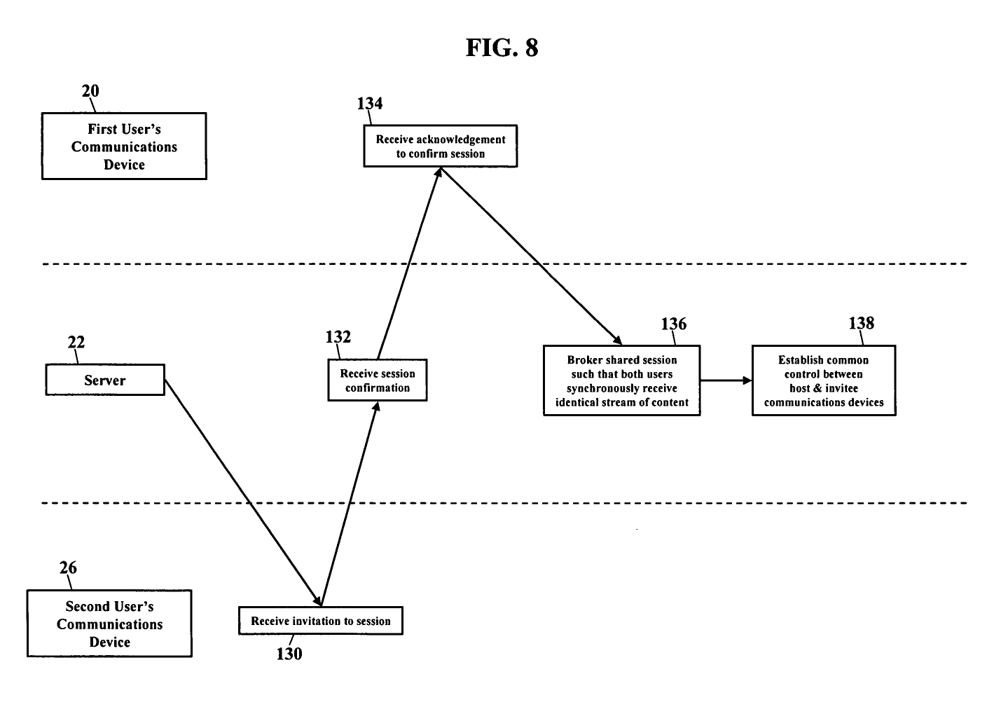

The process continues with FIG. 8. The server 22 sends an invitation to the second user's communications device 26 (Step 130). The second user's communications device 26 sends a session confirmation (Step 132). The server 22 sends an acknowledgement to the first user's communications device 20 to confirm the session (Step 134). The server 22 brokers a shared session such that both users synchronously receive the same stream of content (Step 136). The server-side collaborative control application (shown as reference numeral 56 in FIGS. 2 and 3) establishes a common control between the hosting first user's communications device 20 and the invitee second user's communications device 26 (Step 138).

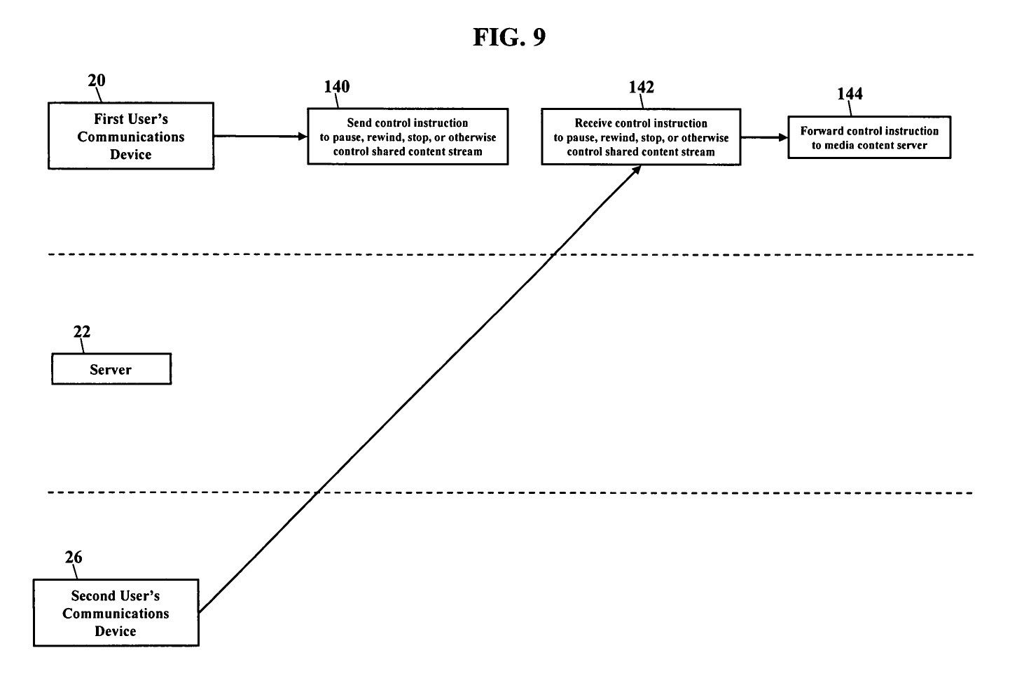

The process continues with FIG. 9. Here control instructions are routed to and through the host. If the first user at the first user's communications device 20 desires to pause, rewind, stop, or otherwise control the shared content stream, the client-side collaborative control application (shown as reference numeral 32 in FIG. 2) operating in the first user's communications device 20 sends an instruction directly to the media content server 30 (Step 140). If the second user similarly wishes to pause, rewind, stop, or otherwise control the shared content stream, the client-side collaborative control application (operating in the second user's communications device 26) sends an instruction to the hosting first user's communications device 20. The first user's communications device 20 then sends an instruction directly to the media content server 30 to implement the second user's desired control (Step 144). That is, instructions from the second user are routed to and through the first user's communications device 20. Here, then, the host device (e.g., the first user's communications device 20) receives all invitee instructions to control the shared content stream. The host device may thus collect all the invitee commands and reissue the commands under an alias identifier. All the invitee control commands thus appear to originate from the authorized hosting device.

Exemplary embodiments are applicable to any content from any source. The host device and the invitee(s) receive identical media content, whether movies, pictures, images, music, text, links, programs, and data. The shared media content may or may not be content that is broadcast over the federally-regulated electromagnetic spectrum. The shared media content may be video-on-demand, online game, or any other content delivered using packetized data and/or network transport streams. If both the host and the invitee(s) subscribe to the same video-on-demand provider, for example, exemplary embodiments allow the host and the invitee to establish collaborative control over the shared media content. Whatever is presented on one user's device (whether the host or the invitee) is simultaneously presented or synchronized on another user's device. Multiple control inputs, from multiple users' communications devices, may control the common experience of shared media content. Multiple communications devices may synchronously receive the same media content, and exemplary embodiments simultaneously, or nearly simultaneously, accept control inputs and/or instructions from all devices. In other exemplary embodiments some users may have locally resident copies of the same content, and the signaling between these users provides synchronization of the playback from their separate sources. These sources could be DVDs or PVR recordings.

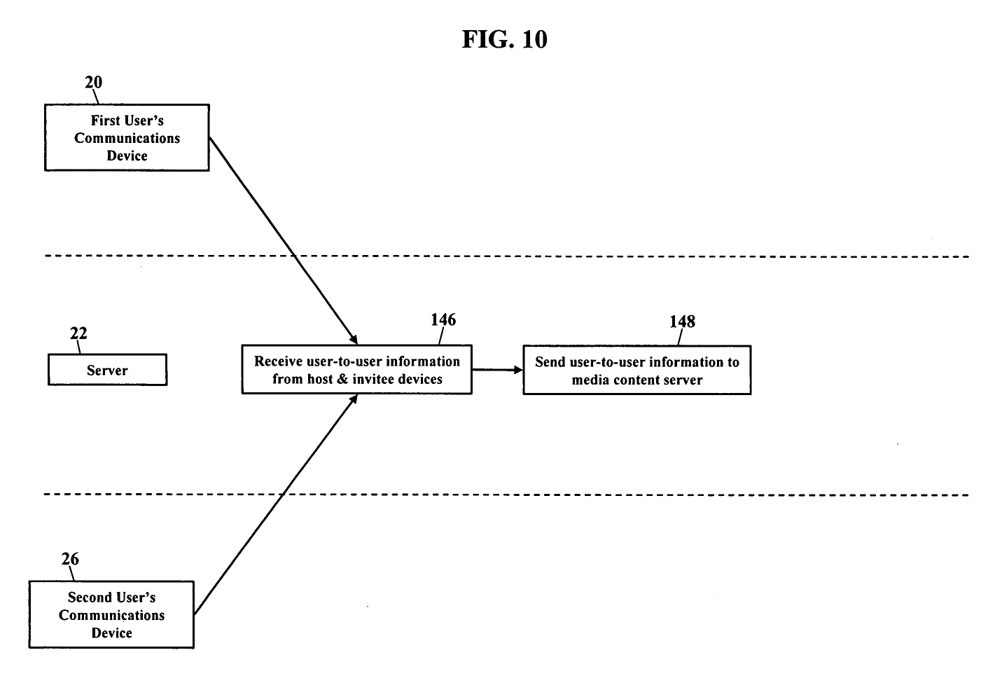

FIG. 10 is a schematic illustrating yet another process of synchronizing media experiences between users, according to still more exemplary embodiments. Here the users also share user-to-user information, such as textual, graphical, and audio commentary. As multiple users experience the same media content, exemplary embodiments permit those users to exchange textual comments, audio comments, and even graphical comments. Whatever is visually/audibly presented on one user's communications device is simultaneously presented or synchronized on another user's communications device. Exemplary embodiments may also be applied to video conferencing, such as picture-in-picture conferencing. As users watch shared content, the users may draw circles around key plays during football games or draw mustaches on actors' faces. Even audible conversation may be communicated between the users' communications devices. Users may converse as they simultaneously view content, such as “Oh, did you see what he just did?” or “Isn't that wild?” Users may share text messages that “pop up” during the shared content. Users may also share pictures, video clips, and other content as they collaborative share media content. Any type of user-to-user information may be exchanged during the shared content. Whether the comments are textual, audio, or graphical, these synchronized comments add to the virtual experience of all users. Whenever the server 22 receives user-to-user information (Step 146), from either the host device or an invitee device, the server 22 sends that user-to-user information to the media content server (Step 148).

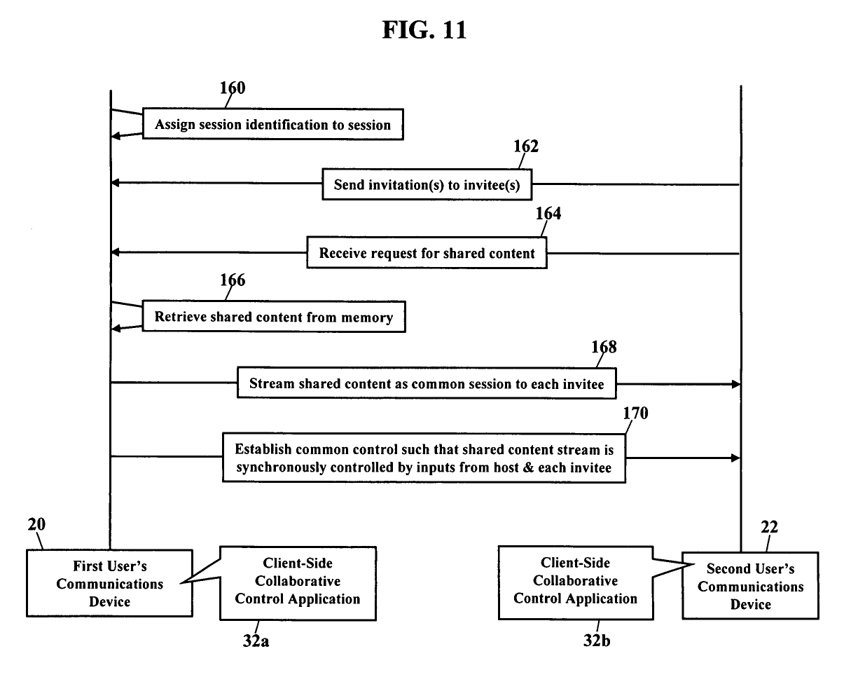

FIG. 11 is a schematic illustrating yet another process of synchronizing media experiences between users, according to still more exemplary embodiments. Here the shared content stream 28 originates from the host. That is, the (hosting) first user's communications device 20 also acts as the media content provider, thus operating as a peer-to-peer content provider. Suppose the first user wishes to collaboratively share home movies, pictures, or other locally-stored content. A third party content provider, therefore, is not required. The first user's communications device 20 stores and sends the shared content stream 28 to the invitees via the communications network 24. Although exemplary embodiments are applicable to any number of users, FIG. 11, again for simplicity, only illustrates two users (e.g., the first user at the first user's communications device 20 and the second user at the second user's communications device 26).

The host sends an invitation. The client-side collaborative control application 26 (operating in the hosting first user's communications device 20) may assign a session identification to the session (Step 160). The hosting first user's communications device 20 sends invitations to each invitee (Step 162). The hosting communications device (e.g., first user's communications device 20) receives a request for the shared content from each invitee (Step 164). The hosting communications device 20 retrieves the shared content from the memory (Step 166). The hosting communications device 20 streams the shared content as a common session to each invitee (Step 168). The hosting communications device 20 establishes a common control between the host device and each invitee device(s) such that the shared content stream is synchronously controlled by inputs from both the host device and from the invitee device(s) (Step 170). Here, then, the hosting user acts as an access point to multimedia content. Control inputs and user-to-user information (such as pausing, playback, rewinding, and even subtitle selection) are synchronized for a common experience.

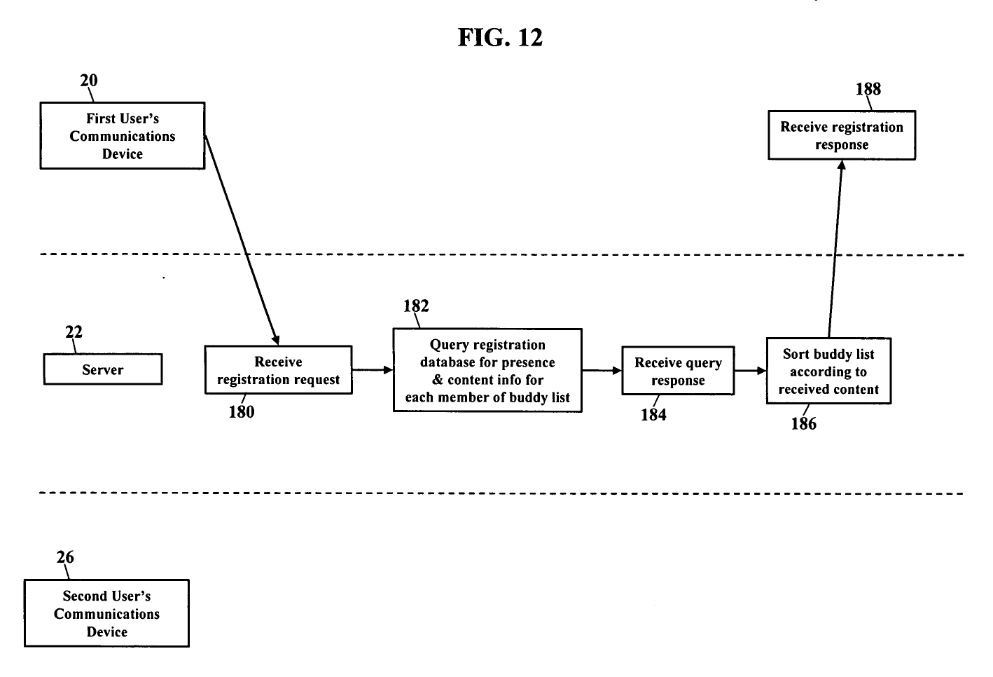

FIG. 12 is a schematic illustrating a process of synchronizing media experiences between users, according to exemplary embodiments. Here the host's buddy list is sorted according to content. If a buddy's online presence indicates that buddy is receiving the same content as the host, then that buddy may be sorted, or elevated, to a hierarchical top portion of the buddy list. If a buddy is not online, or is not receiving the same content as the host, then that buddy may be listed in a lower hierarchical portion of the buddy list. When the first user's communications device 20 sends the registration request to the server 22 (Step 180), the server 22 queries the registration database for the user's buddy list (Step 182). The registration database associates the requesting first user's identification to members in the buddy list. After the server 22 receives a query response from the registration database (Step 184), the server 22 sorts the buddy list according to the content each member is receiving (Step 186). Those buddies who are receiving the same content may be more willing to collaborate and to share a common experience, so those members are arranged at or near a top portion of the buddy list. Those buddies may additionally or alternatively be more prominently listed, such as bold fonting, color fonting, or different fonting. The server sends the registration response (Step 188) identifying the sorted content being received by each member's device in the buddy list. The process then continues as previously explained.

The buddy list may be further configured. Some members of the buddy list (shown as reference numeral 70 in FIG. 2) may not wish to have their online status and/or received content updated in the registration database (shown as reference numeral 66 in FIG. 2). The buddy list, and/or the server-side collaborative control application, and/or the client-side collaborative control application, then, may be configured as the host or the buddy desires. Each buddy, for example, may send instructions or messages to have their presence and/or content information excluded from the buddy list.

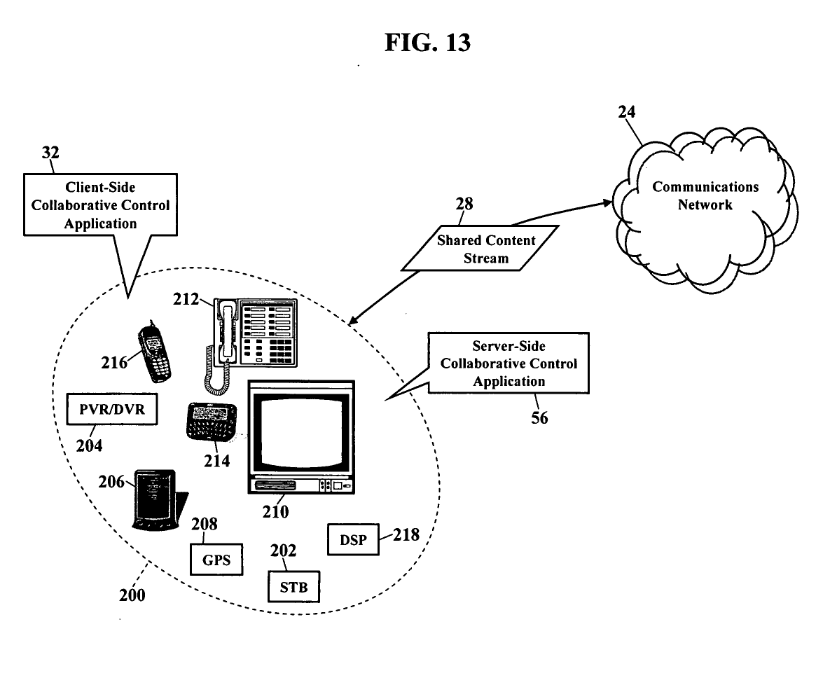

FIG. 13 depicts other possible operating environments, according to more exemplary embodiments. FIG. 13 illustrates that the client-side collaborative control application 32 and/or the server-side collaborative control application 56 may alternatively or additionally operate within various other communications devices 200. FIG. 13, for example, illustrates that the client-side collaborative control application 32 and/or the server-side collaborative control application 56 may entirely or partially operate within a set-top box (202), a personal/digital video recorder (PVR/DVR) 204, personal digital assistant (PDA) 206, a Global Positioning System (GPS) device 208, an interactive television 210, an Internet Protocol (IP) phone 212, a pager 214, a cellular/satellite phone 216, or any computer system and/or communications device utilizing a digital signal processor (DSP) 218. The communications device 200 may also include watches, radios, vehicle electronics, clocks, printers, gateways, and other apparatuses and systems. Because the architecture and operating principles of the various communications devices 200 are well known, the hardware and software components of the various communications devices 200 are not further shown and described. If, however, the reader desires more details, the reader is invited to consult the following sources, all incorporated herein by reference in their entirety: LAWRENCE HARTE et al., GSM SUPERPHONES (1999); SIEGMUND REDL et al., GSM AND PERSONAL COMMUNICATIONS HANDBOOK (1998); and JOACHIM TISAL, GSM CELLULAR RADIO TELEPHONY (1997); the GSM Standard 2.17, formally known Subscriber Identity Modules, Functional Characteristics (GSM 02.17 V3.2.0 (1995-01))”; the GSM Standard 11.11, formally known as Specification of the Subscriber Identity Module—Mobile Equipment (Subscriber Identity Module—ME) interface (GSM 11.11 V5.3.0 (1996-07))”; MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004).

The exemplary embodiments may be applied regardless of networking environment. The user communications devices 20 and 26, and the server 22, may operate using wired or wireless principles. The communications network 24 may be a cable network operating in the radio-frequency domain and/or the Internet Protocol (IP) domain. The communications network 24 may have POTS components and/or features. The communications network 24, however, may also include a distributed computing network, such as the Internet (sometimes alternatively known as the “World Wide Web”), an intranet, a local-area network (LAN), and/or a wide-area network (WAN). The communications network 24 may include coaxial cables, copper wires, fiber optic lines, and/or hybrid-coaxial lines. The communications network 24 may even include wireless portions utilizing any portion of the electromagnetic spectrum and any signaling standard (such as the I.E.E.E. 802 family of standards, GSM/CDMA/TDMA or any cellular standard, and/or the ISM band). The concepts described herein may be applied to any wireless/wireline communications network or communications device, regardless of physical componentry, physical configuration, or communications standard(s).

The client-side collaborative control application 32 and/or the server-side collaborative control application 56 may be physically embodied on or in a computer-readable medium. This computer-readable medium may include CD-ROM, DVD, tape, cassette, floppy disk, memory card, and large-capacity disk (such as IOMEGAO, ZIP®, JAZZ®, and other large-capacity memory products (IOMEGAO, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-subscribers, licensees, and assignees. These types of computer-readable media, and other types not mention here but considered within the scope of the exemplary embodiments, allow the client-side and/or the server-side collaborative control application to be easily disseminated. A computer program product comprises the client-side collaborative control application and/or the server-side collaborative control application stored on the computer-readable medium. The client-side collaborative control application and/or the server-side collaborative control application comprise computer-readable instructions/code for synchronizing media experiences.

Exemplary embodiments may be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol mobile phone, or a wireless pager.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method for synchronizing a media experience, comprising:
receiving a request from a first device for a shared collaborative session between the first device and at least one second device; and
establishing a common control between the first device and the second device such that a shared content stream is synchronously controlled by inputs from both the first device and from the second device.

2. A method according to claim 1, further comprising the steps of:
receiving a registration request comprising the first device's identification;
querying a registration database for the first device's identification, the registration database associating the first device's identification to members in a buddy list and to content currently being received by each member in the buddy list; and
sending a registration response that identifies the content being received by each member device in the buddy list.

3. A method according to claim 1, further comprising the step of sending an invitation to the second device to join the shared collaborative session, the invitation comprising a session identification assigned to the session.

4. A method according to claim 1, wherein the step of receiving the request comprises receiving the request from a host device, and wherein the step of establishing the common control comprises establishing the common control between the host device and an invitee device.

5. A method according to claim 1, further comprising the step of sorting the members in the buddy list according to those members who are, and who are not, receiving the same content as the first device.

6. A method according to claim 1, further comprising the steps of i) receiving inputs to control the shared content stream from both the first device and from the second device and ii) sending an instruction to implement the control.

7. A method according to claim 1, further comprising the steps of i) receiving an input to control the shared content stream from the second device and ii) forwarding the input to the first device such that all inputs are sent from the first device.

8. A system, comprising:
a collaborative control application stored in memory; and
a processor communicating with the memory,
wherein the processor receives a request from a first device for a shared collaborative session between the first device and at least one second device, and the processor establishes a common control between the first device and the second device such that a shared content stream is synchronously controlled by inputs from both the first device and from the second device

9. A system according to claim 8, wherein the processor:
i) receives a registration request comprising the first device's identification;
ii) queries a registration database for the first device's identification, the registration database associating the first device's identification to members in a buddy list and to content currently being received by each member in the buddy list; and
iii) sends a registration response that identifies the content being received by each member device in the buddy list.

10. A system according to claim 8, wherein the processor sends an invitation to the second device to join the shared collaborative session, the invitation comprising a session identification assigned to the session.

11. A system according to claim 8, wherein the processor receives the request from a host device, and wherein the processor establishes the common control between the host device and an invitee device.

12. A system according to claim 8, wherein the processor sorts the members in the buddy list according to those members who are, and who are not, receiving the same content as the first device.

13. A system according to claim 8, wherein the processor i) receives inputs to control the shared content stream from both the first device and from the second device and ii) sends an instruction to implement the control.

14. A system according to claim 8, wherein the processor i) receives an input to control the shared content stream from the second device and ii) forwards the input to the first device such that all inputs are sent from the first device.

15. A computer program product storing computer code for performing the steps:
receiving a request from a first device for a shared collaborative session between the first device and at least one second device; and
establishing a common control between the first device and the second device such that a shared content stream is synchronously controlled by inputs from both the first device and from the second device.

16. A computer program product according to claim 15, further comprising computer code for:
receiving a registration request comprising the first device's identification;
querying a registration database for the first device's identification, the registration database associating the first device's identification to members in a buddy list and to content currently being received by each member in the buddy list; and
sending a registration response that identifies the content being received by each member device in the buddy list.

17. A computer program product according to claim 15, further comprising computer code for receiving the request from a host device, and for establishing the common control between the host device and an invitee device.

18. A computer program product according to claim 15, further comprising computer code for sorting the members in the buddy list according to those members who are, and who are not, receiving the same content as the first device.

19. A computer program product according to claim 15, further comprising computer code for i) receiving inputs to control the shared content stream from both the first device and from the second device and ii) sending an instruction to implement the control.

20. A computer program product according to claim 15, further comprising computer code for i) receiving an input to control the shared content stream from the second device and ii) forwarding the input to the host device such that all inputs are sent from the first device.
